(19) United States
(12) Patent Application Publication
(10) Pub. No.: US 2001/0021295 A1
(43) Pub. Date: Sep. 13, 2001

(54) Laser light interrupting device

(76) Inventor: Kazuki Yoshida, Tokyo (JP)

Correspondence Address: McGinn & Gibb, PLLC, Suite 200, 8321 Old Courthouse Road, Vienna, VA, 22182-3817, US

(21) Appl. No.: 09/800,906

(22) Filed: Mar. 8, 2001

(30) Foreign Application Priority Data
Mar. 9, 2000 (JP) 2000-065483

(51) Int. Cl. G02B 6/42

(52) U.S. Cl. 385/88

(57) ABSTRACT

A laser light-interrupting device which is easy to mount. The device includes a mounting member having a mounting portion for mounting the member to a panel lying above the opening, and an extension extending from the front panel surface. The mounting member has a shaft on its distal end side and a flange on its distal end, the shaft extending perpendicular to the panel surface. A plate member is rotationally mounted on the shaft and profiled so as to be rotated by its own weight. The plate member is at a standstill in register with the opening of the optical connector, when the optical fiber cable is not connected, to cover the entire front surface of the opening in the optical connector to interrupt the laser light.

### FIELD OF THE INVENTION

This invention relates to a laser light-interrupting device for an optical connector, for example, a laser light interrupting device for interrupting the laser light straying from the optical connector when an optical fiber cable is not connected to the optical connector. More particularly, it relates to a laser light-interrupting device which is simplified in structure, easy to mount and operate, low in cost and which is superior in safety.

### BACKGROUND OF THE INVENTION

The laser light, if incident on an eye, possibly leads to loss of sight. So, in a field handling an optical connector and an optical fiber plug, measures are taken not to permit the laser light leaking out at the optical connector from being viewed directly when the optical fiber cable is not connected to the optical connector. As conventional measures to prevent the laser light from being viewed directly, it has been known to attach a label for giving a warning, or to close an opening of the optical connector by a shutter member.

### SUMMARY OF THE DISCLOSURE

There is much desired in the conventional art as follows.

Although the warning label represents measures to instigate the user's attention not to view the laser light directly, an operator does not necessarily see this indication. That is, there is a possibility that the user engrossed in his or her operation is unaware of the indication and proceeds to dismount the fiber plug, or that the user sees the indication but view the laser light directly through error. Since the laser light outside the visible light range cannot be observed with naked eyes, it is difficult to decide whether or not the situation is risky.

As means for interrupting the opening of the optical connector with the shutter member, there has been known a technique of manually closing the opening of the optical connector using a cover. This technique resides in mounting a threaded type or fitting type cover on the optical connector to interrupt the laser light. Since in this case the cover is mounted after dismounting the fiber plug, there is a risk that the user directly views the laser light when mounting the cover, or forgets mounting the cover.

As another example of interrupting the opening of the optical connector with the shutter member, there is known a configuration having an opening/closing mechanism for interrupting the laser light and also having a plate with spring restoration force. This technique resides in closing the plate under the restoration force of the spring, at the same time as the fiber plug is dismounted from the optical connector, to interrupt the laser light straying from the opening of the optical connector. In this case, since the plate automatically interrupts the light axis, there is no risk of the user directly seeing the laser light through error. However, there is a demerit that, since the hinge or the spring is used, the cost is raised due to the complicated structure.

As another technique for closing the opening of the optical connector by the shutter member, there is also known an adapter fitted with a laser light interrupting mechanism. This technique resides in fitting a laser light interrupting mechanism in the conventional adapter. In this case, there is a demerit that the interrupting mechanism is difficult to mount such as to maintain the pre-existing shape, and that the cost is increased due to the complicated structure. If the adapter is to conform to the actual device configuration, it may be necessary to change the design of the existing structure significantly.

As another example of interrupting the opening of the optical connector with the shutter member, there is known a configuration in which a plate interrupts the laser light by its own weight. This technique resides in such that an opening/closing mechanism, such as a hinge, is provided on the top of a plate used for interrupting the laser light, with the plate surface interrupting the laser light lying on the same plane as the plane including the rotational axis. There is provided a stop for causing the plate rotation to be halted at the interrupting position to prevent the plate rotating by its own gravity from colliding against the opening of the optical connector. Although the structure is simplified as compared to the case of using the restoration force of the spring, the operation of hoisting the Plate for opening the shutter is required, and hence there is a fear of inferior tractability in such a case wherein a finger other than the finger holding the optical fiber plug or the hand opposite to that holding the optical fiber plug is used. Moreover, in connecting the optical fiber plug, there is a risk for the user to peep through the optical connector to see the laser light directly when opening the shutter.

It is therefore a primary object of the present invention to provide a laser light interrupting device which is easy to mount and which assures reliable laser light interrupting effect.

It is a second object of the present invention to provide a laser light-interrupting device, which can be used without risk.

It is a third object of the present invention to provide a laser light-interrupting device, which can give a warning against a danger.

It is a fourth object of the present invention to provide a laser light-interrupting device, which is simplified in structure, and low in cost.

In one aspect, the present invent ion provides a laser light interrupting device in which the laser light straying from an optical connector provided in an opening formed in a panel when an optical fiber cable is not connected to the optical connector, in which the laser light interrupting device includes a mounting member having a mounting portion for mounting the member to a portion of the front surface of the panel lying above the opening and an extension extending from the front panel surface; and a plate member rotatably mounted on the shaft and prof i led so as to be rotated by its own gravity. The mounting member has a shaft on its distal end side and a flange on its distal end. The shaft has a direction perpendicular to the panel surface as its axial direction. The plate member is at a standstill in register with the opening of the optical connector, when the optical fiber cable is not connected, to cover the entire front surface of the opening in the optical connector to interrupt the laser light.

In the above-defined laser light-interrupting device, the panel has a hole or holes for mounting the mounting portion of the mounting member. The mounting member is a unitary member of a flexible material. The mounting member has a pawl or pawls for fitting in the hole or holes for securing. The plate member has a cutout having a portion opened, the plate member being rotatably supported by the shaft and fitted in the cut-out.

In the laser light-interrupting device, the panel has a hole for mounting the mounting portion of the mounting member, the mounting portion being a male thread engaged in the hole.

In a second aspect, the present invention includes a laser light interrupting device in which the laser light straying from an optical connector provided in an opening formed in a panel is interrupted when an optical fiber cable is not connected to the optical connector, in which the laser light interrupting device includes a threaded member having a male threaded portion on one end thereof for being threaded to a hole of the panel adapted for accommodating the optical connector; an extension extending from the front panel surface, a female threaded portion perpendicular to the front panel surface on the opposite end thereof; a screw with a collar threaded to the female threaded portion; and a plate member having a through-hole for being passed through by the screw and profiled so as to be rotated by its own gravity. The plate member is at a standstill in register with the opening of the optical connector, when the optical fiber cable is not connected, to cover the entire front surface of the opening in the optical connector to interrupt the laser light. There is also included a bush interposed between the collar of the screw and the plate member.

In the above-defined laser light-interrupting device, the plate member is of a visible light converting glass.

In the above-defined laser light interrupting device it is desirable that the laser light interrupting device is applied to optical communication equipment and the panel is a portion of a casing of the optical communication equipment.

### BRIEF DESCRIPTION OF THE DRAWINGS

FIG. 1 is a perspective view showing a laser light interrupting device according to an embodiment 1 of the present invention.

FIG. 2 is a perspective view showing the mounting state of the laser light interrupting device according to the embodiment 1 of the present invention and particularly showing the interconnected state of the optical connector and the optical fiber cable.

FIG. 3 is a perspective view showing the operation of a plate with the optical fiber cable disconnected from the optical connector.

FIG. 4 is a perspective view of the laser light-interrupting device according to an embodiment 2 of the present invention.

FIG. 5 is a schematic view showing the state in which the laser light is converted into the visible light at the time of interruption by the laser light-interrupting device embodying the present invention.

### PREFERRED EMBODIMENTS OF THE INVENTION

In one aspect of the present invention, there is provided a laser light interrupting device in which the laser light straying from an optical connector provided in an opening formed in a panel is interrupted when an optical fiber cable is not connected to the optical connector, in which the laser light interrupting device includes:

a mounting member having a mounting portion for mounting the member to a portion of the front surface of the panel lying above the opening, an extension extending from the front panel surface, and a plate member rotationally mounted on the shaft and profiled so as to be rotated by its own weight, the mounting member having a shaft on its distal end side and a flange on its distal end. The shaft has a direction perpendicular to the panel surface as its axial direction. The plate member is at a standstill in register with the opening of the optical connector, when the optical fiber cable is not connected, to cover the entire front surface of the opening in the optical connector to interrupt the laser light.

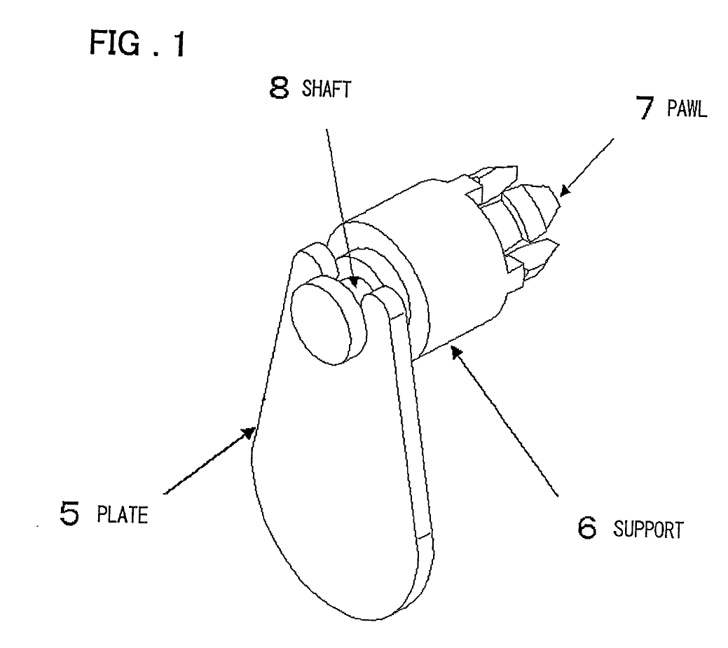

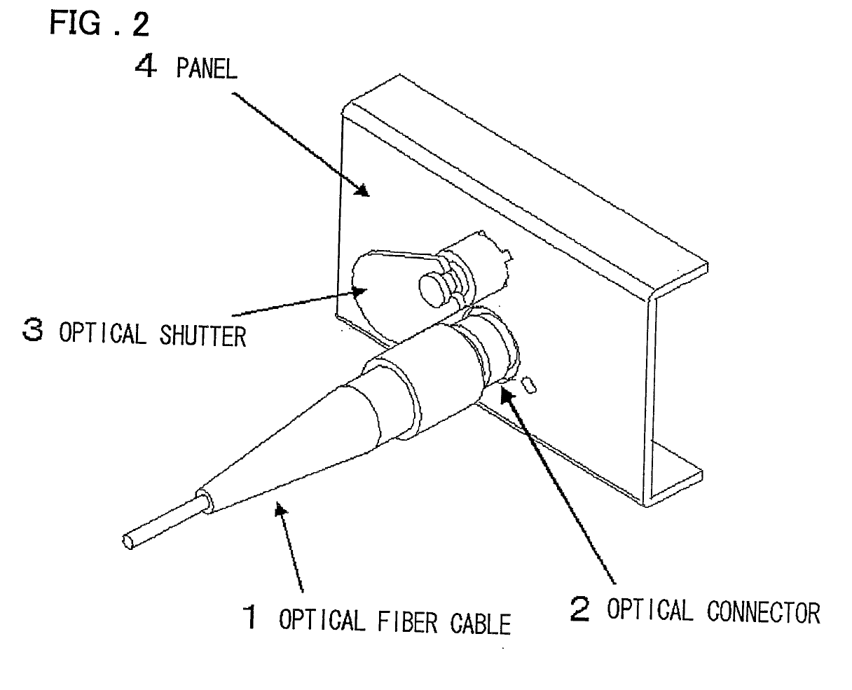

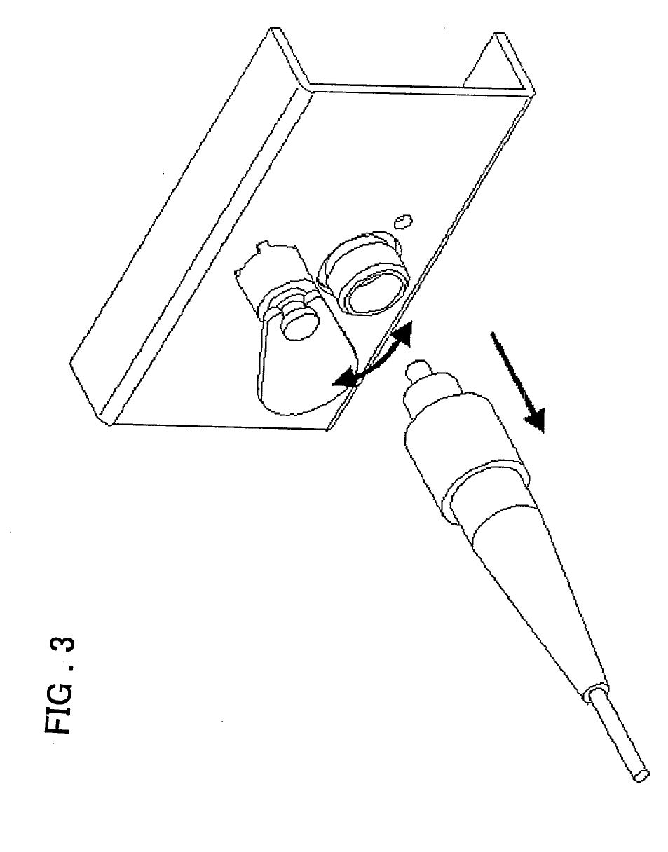

Referring to the drawings, certain preferred embodiments of the present invention are explained in detail. FIG. 1 is a perspective view showing a laser light interrupting device according to an embodiment 1 of the present invention. FIG. 2 is a perspective view showing the mounting state of the laser light interrupting device according to the embodiment 1 of the present invention and particularly showing the interconnected state of the optical connector and the optical fiber cable. FIG. 3 is a perspective view showing the operation of a plate with the optical fiber cable disconnected from the optical connector, and particularly showing the operation of a plate in such a state where the optical fiber cable is disconnected from the optical connector.

Referring to FIG. 1, the laser light-interrupting device includes a plate 5 and a support 6.

The plate 6 includes a pawl 7 for securing the support 6 to a portion of the front surface of the panel 4, as a component of a casing of an optical communication terminal, lying above an opening of the optical connector, and a cylindrical portion extending from the front surface of the panel 4. The support 6 also includes a shaft 8 which has the direction perpendicular to the plate surface of the panel 4 as its axial direction and which rotationally supports the plate 5. The distal end of the shaft 8 is formed as a flange. The support 6 performs the role of rotationally supporting the plate 5 for holding the plate on the panel of the optical interfacing unit of the optical communication equipment.

The plate 5 is a spatula-shaped member rotationally mounted on the shaft 8 and having a cutout which is concentric as the shaft 8, with the spatula-shaped member being rotated by its own weight (i.e., gravity exerted to the Plate itself). When the optical fiber cable is not connected in position, the plate 5 is at a standstill at a position towards the opening of the optical connector or cover the entire front surface of the opening of the optical connector to interrupt the laser light. Since the shaft 8 of the support rotationally supports the cutout, the plate 5 can be rotated about the shaft 8 of the support as the center of rotation. With the plate 5 being spatula-shaped, the trajectory of the rotational movement of the plate 5 passes through the optical axis of the optical connector, such that, no matter to which angle the plate 5 is rotated, the center of gravity of the plate 5 is automatically moved at all times to a position directly below the center of rotation to intercept the optical axis. The plate has a plate area that is large sufficient to cover the opening end of the optical connector.

In the embodiment 1, the support 6 needs to be shaped so as to be fitted into a hole of the panel 4. With this in view, the support 6 is formed of a resin to render the support elastic, while it is molded in view of productivity. The plate 5 is adapted for being fitted on the support by taking advantage of the resiliency proper to the resin.

An optical communication equipment, not shown, outputs optical signals to outside by connecting the optical fiber cable 1 to the optical connector 2 of the panel 4 as the optical interfacing unit of the equipment. The panel 4 includes the optical connector 2 and an optical shutter 3, as the laser light-interrupting device. The optical shutter 3 is made up of the plate 5 and the support 6 in FIG. 1. The laser light output from the optical connector 2 is interrupted by the plate of the optical shutter 3.

When the optical fiber cable is connected to the optical connector, the plate 5 is moved within a range of rotation in such a manner as to clear an optical fiber cable plug. If the optical fiber cable plug is removed, the plate is rotated by its own weight counterclockwise as indicated by arrow, as shown in FIG. 3, and comes to a standstill state at a position interrupting the optical axis of the optical connector.

By the above operation, there is realized an effect that, if the optical fiber cable plug is not connected to the optical interfacing unit, the user's attention is invoked against the possible risk otherwise caused by the output laser light to prevent the possible damage to his or her eyeballs.

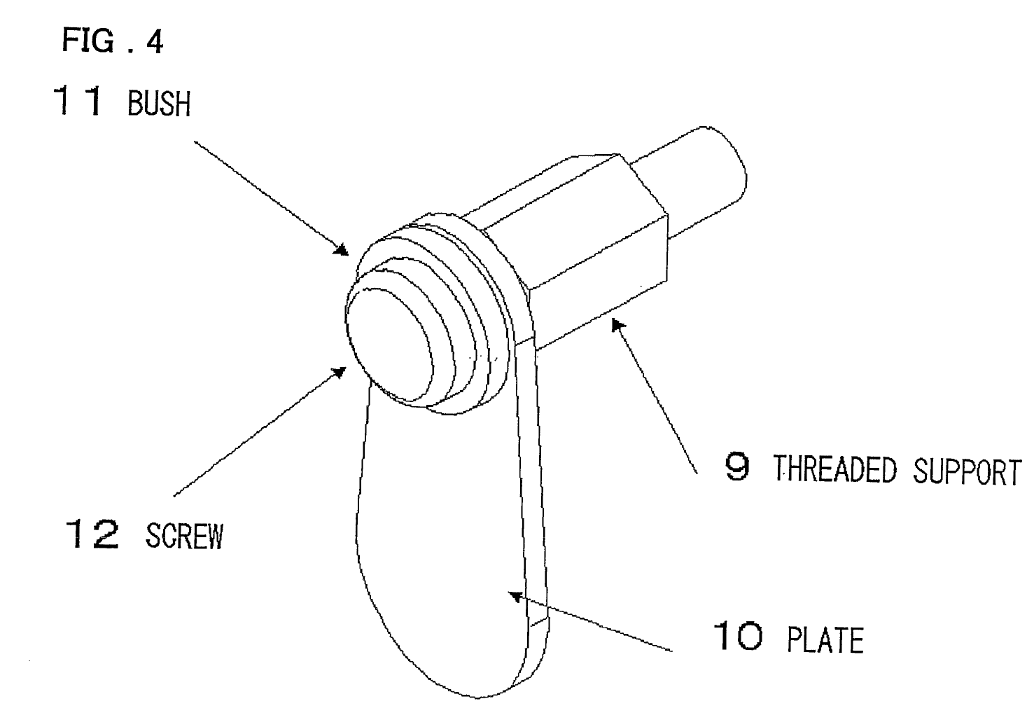

FIG. 4 is a perspective view of the laser light-interrupting device according to an embodiment 2 of the present invention. The laser light interrupting device of the present embodiment 2 can be manufactured using a routine machining or press-working technique without the necessity of using dedicated molds. Although resin molding is used in the embodiment 1 in which a pawl structure is provided for securing the support to the panel, it is also possible to use a threaded structure shown in the embodiment 2.

This laser light-interrupting device includes a threaded support 9, a plate 10, a bush 11 and a screw 12. The threaded support 9 has its one end formed as a male screw for being threadedly attached to the panel and has its other end formed as a female screw for being threadedly attached to the plate 10. The plate 10 is a spatula-shaped member and has a through-hole in a portion thereof. Th plate 10 is rotationally mounted to the threaded support 9 by a screw 12. Between a collar of the screw 12 and the plate 10, a thin cylindrically-shaped bush 11 is interposed to permit smooth rotation of the plate 10 when the screw 12 is passed through a tapped hole in the plate 10.

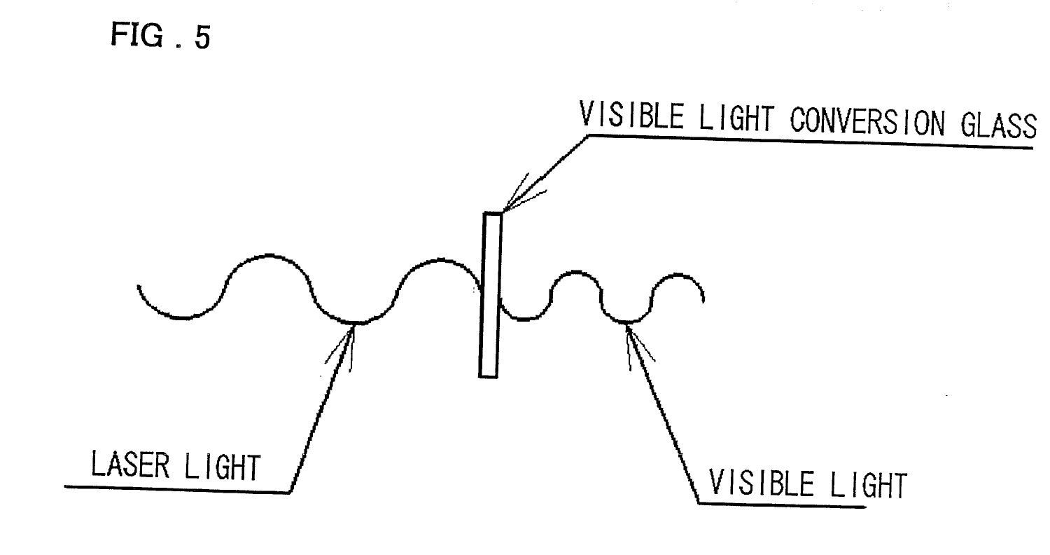

A further embodiment of the present invention is explained. FIG. 5 is a schematic view showing the state in which the laser light is converted into the visible light at the time of interruption by the laser light-interrupting device embodying the present invention. By forming the plate 5, shown in FIG. 1, of a visible light conversion glass material which exploits the upward conversion phosphorescent effect proper to rare earth elements, the laser light illuminated from the back side surface of the visible light conversion glass is converted in the glass into the visible light to radiate the visible light from the front side surface of the visible light conversion glass to permit the optical path to be observed with naked eyes. By this measure, the invisible light can be converted into visible light which exhibits the presence of the light beam at the connector end, and provides caution to the operator.

The meritorious effects of the present invention are summarized as follows.

According to the present invention, the laser light output from the optical interfacing unit of e.g., an optical communication equipment can be positively interrupted by the plate rotatable by its own weight, even in case the optical fiber cable is not connected to the optical connector.

According to the present invention, since the laser light interrupting device is a component distinct from the optical connector, the laser light-interrupting device can be applied to a wide variety of optical connector sorts.

According to the present invention, since the plate is rotatable about a shaft perpendicular to the panel, optical fiber plugmounting/dismounting and the shutter opening/closure may be achieved significantly by a one-hand operation.

According to the present invention, the structure by the mounting member and the plate is simplified to facilitate the manufacture and to lower the cost.

According to the present invention, since the laser light is interrupted by the plate employing the visible light conversion glass, the plate material illuminated with the laser light on interruption emits visible light to render monitoring possible to advise the user of risk.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. A laser light interrupting device in which the laser light straying from an optical connector provided in an opening formed in a panel when an optical fiber cable is not connected to said optical connector, said laser light interrupting device comprising:
a mounting member having a mounting portion for mounting the member to a portion of the front surface of said panel lying above said opening and an extension extending from said front panel surface, said mounting member having a shaft on its distal end side and a flange on a distal end of the shaft, said shaft having a direction perpendicular to said panel surface; and
a plate member rotatably mounted on said shaft and profiled so as to be rotated by its own gravity, said plate member being at a standstill in register with said opening of said optical connector, when said optical fiber cable is not connected, to cover the entire front surface of the opening in said optical connector to interrupt the laser light.

2. The laser light interrupting device as defined in claim 1 wherein said panel has a hole or holes for mounting the mounting portion of said mounting member;
said mounting member is a unitary member of a flexible material;
said mounting member has a pawl or pawls for fitting in said hole or holes for securing; and wherein
said plate member has a cut-out having its portion opened, said plate member being fitted in said cut-out and rotatably supported by said shaft.

3. The laser light interrupting device as defined in claim 1 wherein said panel has a hole for mounting the mounting portion of said mounting member;
said mounting portion being a male thread to be engaged in said hole.

4. A laser light interrupting device in which the laser light straying from an optical connector provided in an opening formed in a panel is interrupted when an optical fiber cable is not connected to said optical connector, said laser light interrupting device comprising:
a threaded member having a male threaded portion on one end thereof for being threaded to a hole of said panel adapted for accommodating said optical connector, an extension extending from said front panel surface, and a female threaded portion perpendicular to said front panel surface on the opposite end thereof;
a screw with a collar for being threaded to said female threaded portion;
a plate member having a through-hole for being passed through by said screw and profiled so as to be rotated by its own weight, said plate member being at a standstill in register with said opening of said optical connector, when said optical fiber cable is not connected, to cover the entire front surface of the opening in said optical connector to interrupt the laser light; and
a bush interposed between the collar of said screw and said plate member.

5. The laser light interrupting device as defined in claim 1 wherein
said plate member is of a visible light converting glass.

6. The laser light interrupting device as defined in claim 4 wherein
said plate member is of a visible light converting glass.

7. The laser light interrupting device as defined in claim 1 wherein
said laser light interrupting device is applied to an optical communication equipment; and
said panel is a portion of a casing of said optical communication equipment.

8. The laser light interrupting device as defined in claim 4 wherein
said laser light interrupting device is applied to an optical communication equipment; and
said panel is a portion of a casing of said optical communication equipment.
